(19) United States
(12) Patent Application Publication
(10) Pub. No.: US 2019/0072961 A1
(43) Pub. Date: Mar. 7, 2019

(54) AUTONOMOUS DRIVING ADJUSTMENT METHOD, APPARATUS, AND SYSTEM

(71) Applicant: DENSO CORPORATION, Kariya-city (JP)

(72) Inventor: Michel XAVIER, Kariya-city (JP)

(21) Appl. No.: 16/122,107

(22) Filed: Sep. 5, 2018

(30) Foreign Application Priority Data
Sep. 7, 2017 (JP) 2017-171913

(51) Int. Cl. G05D 1/00; G05B 13/04; B60W 30/16; B60W 30/14; B60W 10/20; B60W 40/08; A63F 13/803

(52) U.S. Cl. CPC G05D 1/0088; G05B 13/041; B60W 30/16; B60W 30/143; B60W 10/20; G06F 3/015; A63F 13/803; B60W 2040/0872; B60W 2710/20; B60W 2750/30; B60W 40/08

(57) ABSTRACT

In an autonomous driving adjustment apparatus, a condition obtainer obtains condition information indicative of a simulation condition of an autonomous driving simulation. A physical activity obtainer obtains physical activity information about a user who is experiencing an autonomous driving simulation. The physical activity information is correlated with the obtained condition information. A parameter adjuster analyses the condition information and the physical activity information to thereby adjust at least one control parameter used for the autonomous driving simulation.

### CROSS REFERENCE TO RELATED APPLICATIONS

This application is based on and claims the benefit of priority from Japanese Patent Application 2017-171913 filed on Sep. 7, 2017, the disclosure of which is incorporated in its entirety herein by reference.

### TECHNICAL FIELD

The present disclosure relates to autonomous driving adjustment methods, apparatuses, and systems. More particularly, the present disclosure relates to these methods, apparatuses, and systems, each of which is capable of performing an autonomous driving simulation.

### BACKGROUND

Driving simulators for vehicles are used to collect information about user's, i.e. driver's, driving operations,

In such driving simulators, Japanese Patent Application Publication No. 2005-077871, which will be referred to as a published patent document, discloses a vehicle driving simulator. The vehicle driving simulator includes an operating unit, a simulation information output unit, a controller, an individual information input unit, an information obtainer, and an information collector.

The operating unit includes various means that enable an operator, i.e. a user, to simulate driving operations. The individual information input unit enables an operator to input his or her individual information. The information obtainer obtains the driving operations simulated by an operator.

The controller is configured to cause the simulation information output unit to visibly and audibly output realistic driving-experience information in accordance with the driving operations obtained by the information obtainer and predetermined driving simulation programs.

In particular, the information collector is configured to collect the driving operations performed by many operators, i.e. users, during simulated driving. This configuration enables a lot of the driving operations simulated by many operators to be easily analyzed.

### SUMMARY

Autonomous driving, in other words self-driving, of vehicles has been developed rapidly. Developers have been studying how autonomous driving control is adjustable for driver's preferences, but they are at the stage of trial and error.

Although the technology disclosed in the published patent document collects driving operations manually performed by users during simulated driving, the technology may fail to disclose how the collected driving operations are reflected on autonomous driving control.

In view of the above circumstances, one aspect of the present disclosure seeks to provide autonomous driving adjustment methods, apparatuses, and systems, each of which is capable of addressing the issue set forth above.

According to a first exemplary aspect of the present disclosure, there is provided an autonomous driving adjustment apparatus for adjusting at least one control parameter used for execution of an autonomous driving simulation. The autonomous driving adjustment apparatus includes a condition obtainer configured to obtain condition information indicative of a simulation condition of the autonomous driving simulation, and a physical activity obtainer configured to obtain physical activity information about a user who is experiencing the autonomous driving simulation. The physical activity information is correlated with the obtained condition information. The autonomous driving adjustment apparatus includes a parameter adjuster configured to analyse the condition information and the physical activity information to thereby adjust the at least one control parameter.

According to a second exemplary aspect of the present disclosure, there is provided an autonomous driving adjustment system. The autonomous driving adjustment system includes a simulator, and an autonomous driving adjustment apparatus. The simulator includes a simulation executor configured to execute an autonomous driving simulation, and an information sender configured to send, to the autonomous driving adjustment apparatus, condition information indicative of a simulation condition of the autonomous driving simulation executed by the simulation executor. The autonomous driving adjustment apparatus includes a condition obtainer configured to obtain the condition information indicative of the simulation condition of the autonomous driving simulation. The autonomous driving adjustment apparatus includes a physical activity obtainer configured to obtain physical activity information about a user who is experiencing the autonomous driving simulation. The physical activity information is correlated with the obtained condition information. The autonomous driving adjustment apparatus includes a parameter adjuster configured to analyse the condition information and the physical activity information to thereby adjust the at least one control parameter.

According to a third exemplary aspect of the present disclosure, there is provided an autonomous driving adjustment method for adjusting at least one control parameter used for execution of an autonomous driving simulation. The autonomous driving adjustment method includes obtaining condition information indicative of a simulation condition of the autonomous driving simulation, and obtaining physical activity information about a user who is experiencing the autonomous driving simulation. The physical activity information being correlated with the obtained condition information. The method includes analyzing the condition information and the physical activity information to thereby adjust the at least one control parameter.

Each of the first to third exemplary aspects is configured to analyze both the condition information indicative of a simulation condition of the autonomous driving simulation and the physical activity information about a user who is experiencing the autonomous driving simulation. This enables user's preferences about the autonomous driving simulation to be obtained. This therefore enables the at least one control parameter to be adjusted based on the user's preferences, making it possible to reflect the adjustment result of the at least one control parameter on actual control of autonomous driving of a vehicle.

### BRIEF DESCRIPTION OF THE DRAWINGS

Other aspects of the present disclosure will become apparent from the following description of embodiments with reference to the accompanying drawings in which:

FIG. 1 is a system configuration diagram schematically illustrating an autonomous driving adjustment system according to a first embodiment of the present disclosure;

FIG. 2 is a block diagram schematically illustrating a control structure of the autonomous driving adjustment system illustrated in FIG. 1;

FIG. 3 is a diagram schematically illustrating that condition files and physical activity files are stored in a storage to be correlated with each other according to the first embodiment of the present disclosure;

FIG. 4 is a flowchart schematically illustrating an autonomous driving adjustment routine according to the first embodiment of the present disclosure;

FIG. 5 is a view schematically illustrating an example of one autonomous driving scene displayed on a display HMD illustrated in FIG. 1;

FIGS. 6A and 6B are a joint view schematically illustrating how an operation in step S104 of FIG. 5 is carried out;

FIG. 7 is a diagram schematically illustrating a control parameter update file according to the first embodiment of the present disclosure; and

FIG. 8 is a system configuration diagram schematically illustrating an autonomous driving adjustment system according to a second embodiment of the present disclosure.

### DETAILED DESCRIPTION OF EMBODIMENT

The following describes embodiments of the present disclosure with reference to the accompanying drawings. Like parts between the embodiments, to which like reference characters are assigned, are omitted or simplified to avoid redundant description.

### First Embodiment

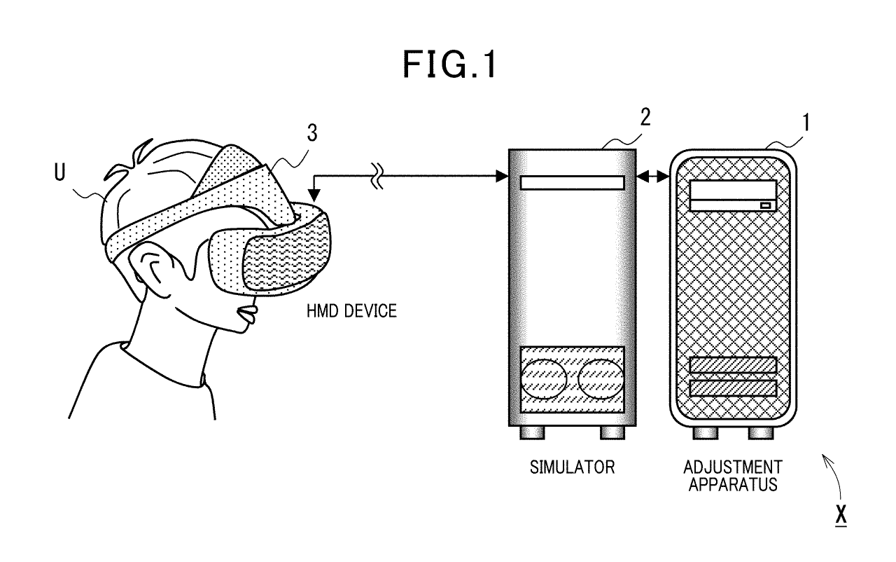

The following describes an example of the configuration of an autonomous driving adjustment system X according to the first embodiment of the present disclosure with reference to FIG. 1.

Referring to FIG. 1, the autonomous driving adjustment system X includes an adjustment apparatus 1, a simulator 2 communicable with the adjustment apparatus 1, and a head mounted display (HMD) device 3 communicable with the simulator 2.

The adjustment apparatus 1 serves as an autonomous driving adjustment apparatus for adjusting the simulator 2.

Specifically, while the simulator 2 is executing an autonomous driving simulation of a vehicle, the adjustment apparatus 1 is configured to obtain and analyze

(1) Conditions indicative of the simulated autonomous driving

(2) User's physical activities

Then, the adjustment apparatus 1 is configured to adjust control parameters 410 of the autonomous driving simulation such that the adjusted control parameters 410 adapt to the user's physical activities, making it possible to reflect the adjusted control parameters 410 in control of the autonomous driving of actual vehicles.

For example, the adjustment apparatus 1 is comprised of a personal computer, a server, or a mainframe computer.

The simulator 2 is, for example, a driving simulator capable of simulating autonomous driving of a vehicle.

Specifically, the simulator 2 is configured to execute autonomous driving simulation programs in a virtual traffic environment; the autonomous driving simulation programs are estimated to be installed in an actual vehicle. This enables a user to experience the autonomous driving in simulation. In order to cause a user U to experience the autonomous driving in simulation, the simulator 2 is configured to

(1) Generate, i.e. render, various images required for the user U to experience various conditions estimated to be encountered during the autonomous driving simulation

(2) Successively display the generated images on the HMD device 3, which will be referred to simply as the HMD 3, mounted on the head of the user U

As the simulator 2, a personal computer including a graphics processing unit (GPU) with high rendering performance, a consumer game machine, a professional-use game machine, a dedicated driving simulator, or a mainframe computer can be used.

The simulator 2 and the HMD 3 can be integrated with each other. Each of the simulator 2 and the HMD 3 can be provided in plurality like the second embodiment.

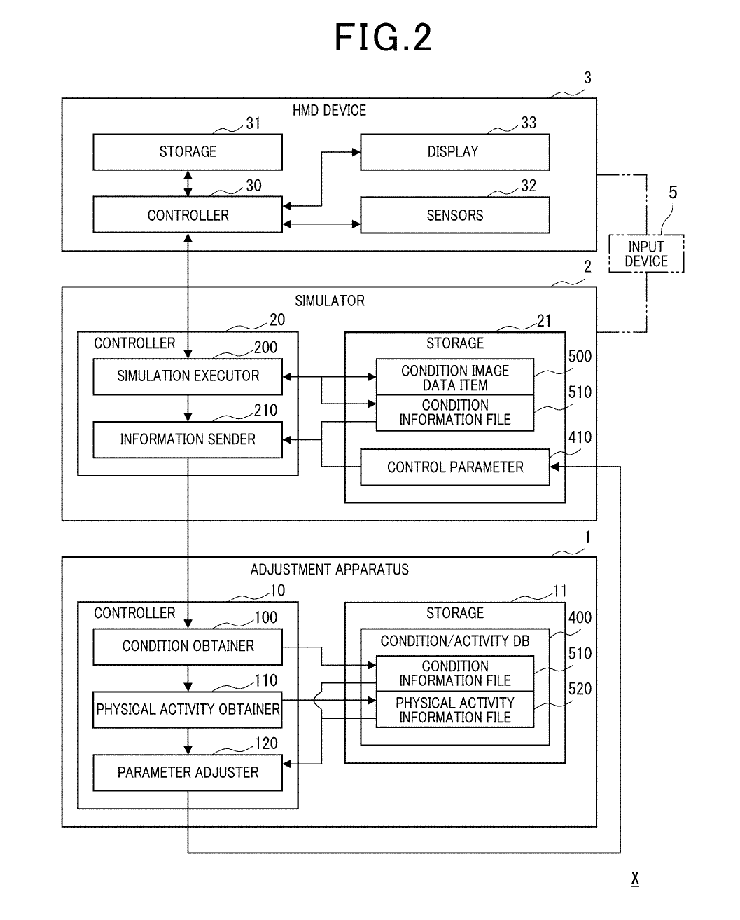

The HMD 3 is configured to sequentially display the images successively sent from the simulator 2. The HMD 3 includes sensors 32 for measuring information indicative of physical activities of the user U (see reference character 520 in FIG. 2).

The following describes an example of the configuration of the adjustment apparatus 1, an example of the configuration of the simulator 2, and the HMD 3 with reference to FIG. 2.

The adjustment apparatus 1 includes various functional units including a controller 10 and a storage 11. Each of the units other than the controller 10 is communicably connected to the controller 10, enabling the controller 10 to control the other units.

The simulator 2 includes various functional units including a controller 20 and a storage 21. Each of the units other than the controller 20 is communicably connected to the controller 20, enabling the controller 20 to control the other units.

The HMD 3 includes various functional units including a controller 30, a storage 31, sensors 32, a display 33, and an input unit 34. The input unit 34 can be eliminated. Each of the units other than the controller 30 is communicably connected to the controller 30, enabling the controller 30 to control the other units.

Each of the controllers 10, 20, and 30 is designed as an information processing unit comprised of a processing unit, such as a central processing unit (CPU), a micro processing unit (MPU), a graphics processing unit (CPU), a tensor processing unit (TPU), a data flow processor (DFP), a digital signal processor (DSP), or an application specific integrated circuit (ASIC).

Each of the storages 11, 21, and 31 is comprised of non-transitory tangible storage media including a main storage unit, such as a random access memory (RAM), and an auxiliary storage unit, such as a read only memory (ROM), a solid state disc (SSD) device, and a hard disc drive (HDD). Each of the storages 11, 21, and 31 can include a flash memory card and/or an optical storage medium. Each of the storages 11, 21, and 31 can include a general-purpose memory for CPUs and a dedicated memory, such as a graphic memory, for OPUs.

Various programs including control programs for causing the controller 10 of the adjustment apparatus 1 to perform various tasks, i.e. routines, are stored in the auxiliary storage unit of the storage 11. The control programs include, for example, an operating system (OS) and application software programs. In addition, various data items usable by the controller 10 are also stored in the storage 11.

Similarly, various programs including control programs for causing the controller 20 to control the simulator 2 are stored in the auxiliary storage unit of the storage 21. The control programs include, for example, an OS and application software programs. In addition, various data items usable by the controller 20 are also stored in the storage 21.

Additionally, various programs including control programs for causing the controller 30 to control the HMD 3 are stored in the auxiliary storage unit of the storage 31. The control programs include, for example, an OS and application software programs. In addition, various data items usable by the controller 30 are also stored in the storage 31.

The controller 10 reads one of the control programs from the auxiliary storage unit of the storage 11, loads the readout control program into the main storage unit of the storage 11, and executes the loaded control program to thereby execute the routine corresponding to the loaded control program. In other words, the controller 10 executes the loaded control program to thereby implement predetermined functional blocks based on the loaded control program. In addition, the controller 10 is configured to control overall operations of the adjustment apparatus 1.

Similarly, the controller 20 of the simulator 2 reads one of the control programs from the auxiliary storage unit of the storage 21, loads the readout control program into the main storage unit of the storage 21, and executes the loaded control program to thereby execute the routine corresponding to the loaded control program. In other words, the controller 20 executes the loaded control program to thereby implement predetermined functional blocks based on the loaded control program. In addition, the controller 20 of the simulator 2 is configured to control overall operations of the simulator 2.

Additionally, the controller 30 of the HMD 3 reads one of the control programs from the auxiliary storage unit of the storage 31, loads the readout control program into the main storage unit of the storage 31, and executes the loaded control program to thereby execute the routine corresponding to the loaded control program. In other words, the controller 30 executes the loaded control program to thereby implement predetermined functional blocks based on the loaded control program. In addition, the controller 30 of the HMD 3 is configured to control overall operations of the HMD 3.

The sensors 32 are each configured to measure a user's physical activity level, such as a user's operation information item or a biological information item.

For example, the sensors 32 include

(1) A head tracking sensor for measuring tracking of the user's head position

(2) An acceleration sensor for measuring movement of a predetermined user's portion

(3) A line-of-sight sensor for measuring the user's line-of-sight

(4) A heart rate sensor for measuring the user's heart rate

(5) A blood pressure sensor for measuring the blood pressure of the user U

(6) A sudorometer for measuring the amount of perspiration based on, for example, change of impedance of the skin of a user's predetermined portion

For example, the measured tracking of the user's head position and the measured movement of the predetermined user's portion are sent from the corresponding sensors to the controller 30 as user's operation information items. The measured change of the user's line-of-sight, the measured user's heart rate, the measured user's blood pressure, and the measured user's amount of perspiration are sent from the corresponding sensors to the controller 30 as biological information items. This enables the HMD 3 to measure information indicative of the physical activities of the user U as a physical activity information file 520. Note that the physical activity file 520 can be comprised of the collection of physical information items measured by the sensors 32.

For example, each of the sensors 32 can be mounted to the housing of the HMD 3 to be abutted or separated from the head of the user U, and operative to measure a corresponding biological information item and/or a corresponding user operation information item. Each of the sensors 32 can be provided independently from the HMD 3, and can be mounted to a corresponding portion of the user U. Each of the sensors 32 can also be combined with another device, and this combination can measure a corresponding physical information item.

The sensors 32 also include a mount detection sensor configured to detect that the HMD 3 is mounted on the head of the user U, and to output a measurement signal indicative of the mounting of the HMD 3 on the head of the user U to the simulator 2.

The display 33 is comprised of, for example, an organic electroluminescence (EL) display, a light emitting diode (LED) array, a retinal projection display comprised of the combination of a micro electro mechanical systems (MEMS) device and a laser beam source, or an optical modulation display.

The display 33 can be designed to cover the user's field of vision, so that the user U sees only a virtual reality space (virtual reality world) based on the images displayed thereby, making it possible for the user U to experience the virtual world. Specifically, the display 33 can be configured to display right and left images for the respective right and left eyes of the user U, thus enabling the user U to see a stereoscopic image based on the right and left images. The display 33 can include at least one optical element, such as a lens or a free form prism.

At least one of the HMD 3 and the simulator 2 can include input devices 7 that enables the user U to enter various instructions to the at least one of the HMD 3 and the simulator 2; the input devices 7 can be communicably connected to the at least one of the HMD 3 and the simulator 2 via cables or radio waves. The input devices 7 can include, for example,

(1) Operation devices provided for the simulator 2, including a steering wheel, an accelerator pedal, and a brake pedal

(2) Virtual-reality operation devices, including acceleration sensors, touch buttons, and/or movable rings

(3) Pointing devices including, for example, touch panels and/or mouses

(4) Keyboards

(5) Voice input devices

At least one of the HMD 3 and the simulator 2 can include

(1) A voice output device for outputting voice messages to feedback, to the user U, various conditions and/or situations in the virtual reality space during the driving simulation

(2) A vibration device for providing, to the user U, vibrations to feedback, to the user U, various conditions and/or situations in the virtual reality space during the driving simulation

(3) A movable seat

When controlled by the at least one of the HMD 3 and the simulator 2, the movable seat is moved to provide, to the user U, various conditions and/or situations in the virtual reality space during the driving simulation.

The adjustment apparatus 1, the simulator 2, and the HMD 3 can be communicably connected to each other by wire or wireless. The wire connections can use universal serial bus (USB) connection cables, high-definition multimedia interface (HDMI®) cables, or dedicated cables. For the wireless connection, these components 1, 2, and 3 can be connected to each other in accordance with at least one of

(1) Wireless Gigabit Alliance (WiGig®) standard

(2) Wireless high-definition multimedia interface (HDMI®) standard

(3) Wireless LAN standard

(4) Bluetooth standard

These components 1, 2, and 3 can also be wirelessly connected to each other via infrared communications or laser communications.

Note that each of the adjustment apparatus 1, the simulator 2, and the HMD 3 can include other components and/or functional modules in addition to the components set forth above. Each component of the adjustment apparatus 1, the simulator 2, and the HMD 3 can include components to be controlled. Some components in the adjustment apparatus 1 can be integrated with each other, some components in the simulator 2 can be integrated with each other, and some components in the HMD 3 can be integrated with each other. For example, the controller 10 and the storage 11 can be integrated with each other, the controller 20 and the storage 21 can also be integrated with each other, and the controller 30 and the storage 31 can further be integrated with each other.

The controller 10 of the adjustment apparatus 1 functionally includes, for example, a condition obtainer 100, a physical activity information obtainer 110, and a parameter adjuster 120. The storage 11 of the adjustment apparatus 1 stores a condition/activity database (DB) 400.

The controller 20 of the control apparatus 2a of the simulator 2 functionally includes, for example, a simulation executor 200 and an information sender 210. The storage 21 of the control apparatus 2a of the simulator 2 stores the control parameters 410 and condition information files 510.

The simulation executor 200 is designed as a known autonomous driving simulator that executes an autonomous driving simulation in accordance with values of the control parameters 410 stored in the storage 21.

Specifically, the simulation executor 200 autonomously controls a virtual user's vehicle, i.e. a virtual own vehicle, in an autonomous driving mode in accordance with the values of the control parameters 410 within the virtual traffic environment adapting to various driving-related conditions.

For example, the control parameters 410 include at least one of

(1) The following distance between the virtual own vehicle and a virtual preceding vehicle

(2) The acceleration or deceleration of the virtual own vehicle

(3) The steering rate of the virtual own vehicle

While controlling the own vehicle in the autonomous driving mode, the simulation executor 200 is configured to render various three-dimensional (3D) objects from a user's view point in, for example, a graphic memory provided in the storage 21.

In particular, the simulation executor 200 successively generates condition image data items 500 in accordance with a selected one of previously prepared autonomous driving scenarios; the condition image data items 500 respectively represent various conditions appearing during execution of the autonomous driving simulation in the selected autonomous driving scenario, and stores the condition image data items 500 in the graphic memory of the storage 21.

Note that the condition image data items 500 can have been prepared for each of the autonomous driving scenarios in the storage 21, and the simulation executor 200 can successively read out condition image data items included in a selected autonomous driving scenario.

The simulation executor 200 successively sends the condition image data items 500 in the selected autonomous driving scenario to the HMD 3, so that the condition image data items 500 are successively displayed on the display 33 of the HMD 3. This makes it possible for a user to experience the selected scenario of the autonomous driving simulation in the virtual reality space based on the successively displayed condition image data items on the display 33.

Each of the successively displayed condition image data items includes at least one of

(1) Vehicle control condition information including the speed of the own vehicle, the steering angle of the own vehicle, and how the own vehicle is accelerated or decelerated

(2) Time condition information

(3) Weather condition information

(4) Road condition information

(5) Traffic condition information

(6) Hazardous condition information

These pieces of information (1) to (6) will also be referred to simply as first to sixth condition information items hereinafter.

The time condition information represents which of time zones the own vehicle is travelling in, the time zones including, for example, a morning zone, a daytime zone, an evening zone, and a night time zone.

The weather condition information represents the weather condition, such as a shine condition, a rain condition, a cloud condition, a snow condition, a fog condition, or a sandstorm condition around the own vehicle

The road condition information includes

1. The type of a road on which the own vehicle is travelling including whether the travelling road is an urban road or an express way, how many lanes the travelling road has, and whether there are oncoming lanes in the travelling road

2. Speed limit of the travelling road

3. Whether passing is permitted for the travelling road

4. Whether there is a stop sign for the travelling road

5. Whether there is an entry sign for the travelling road

6. Whether a caution falling-rocks sign for the travelling road

7. Whether a caution children sign for the travelling road

8. Whether there are other traffic regulations for the travelling road

The traffic condition information includes traffic conditions around the own vehicle at the current time, which include

1. Other objects, such as other vehicles, pedestrians, and/or obstacles, located on the travelling road ahead of the own vehicle at the current time

2. An average speed of the other vehicles travelling in front of the own vehicle

The hazardous condition information includes hazard situations in the estimated travelling course of the own vehicle or its peripheral area; the hazard situations include, for example, a situation where there are obstacles, a situation where there is at least one sinkhole in at least one road, a situation where there are cargoes fallen on at least one road, and a situation where there is at least one accident happened in at least one road.

Specifically, at least one of the first to sixth condition information items shows each of the autonomous driving scenes in the selected autonomous driving scenario.

That is, while rendering the condition image data items 500, i.e. the autonomous driving scenes, on the display 33 of the HMD 3, the simulation executor 200 generates condition information files 510 each including at least one of the first to sixth condition information items; each of the condition information files 510 shows a corresponding one of the autonomous driving scenes in the selected autonomous driving scenario. Note that each condition information file 510 can be comprised of the collection of information items.

The simulation executor 200 temporarily stores the condition information files 510 in the storage 21.

The simulation executor 200 can store each condition information file 510 while categorizing the condition information file 510 into the first to sixth information items.

The simulation executor 200 can store each condition information file 510 in the storage 21 such that the time of the corresponding file being stored is assigned to the condition information file 510. This enables whether a condition information file 510 stored in the storage 21 at a current time is changed by at least the predetermined threshold amount from the condition information file 510 stored at an immediately previous to the current time to be easily determined.

The simulation executor 200 can be configured to execute the autonomous driving simulation to cause a user to experience the autonomous driving of the own vehicle.

The information sender 210 is configured to send, to the adjustment apparatus 1, the condition information file 510 showing a corresponding one of the autonomous driving scenes each time the simulation executor 200 generates the condition information file 510 and stores it in the storage 21. Note that the adjustment apparatus 1 can be configured to successively obtain the condition information file 510 each time the simulation executor 200 generates the condition information file 510 and stores it in the storage 21.

That is, when the condition information file 510 is generated by the simulation executor 200, the condition information file 510 is sent to the adjustment apparatus 1 from the information sender 210.

The information sender 210 can be configured to receive the measurement signals sent from the sensors 32 of the HMD 3, and send, to the adjustment apparatus 1, the measurement signals sent from the sensors 32 of the HMD 3.

The condition obtainer 100 is configured to successively obtain the condition information file 510 showing a corresponding one of the autonomous driving scenes and store it in the condition/activity DB 400 each time the condition information file 510 is generated by the simulation executor 200.

Like the simulation executor 200, the condition obtainer 100 is configured to store the condition information file 510 in the condition/activity DB 400 while categorizing the condition information file 510 into the first to sixth information items. If the condition information file 510 has been categorized into the first to sixth information items, the condition obtainer 100 can store the categorized condition information file 510 in the condition/activity DB 400.

The condition obtainer 100 can store the condition information file 510 in the condition/activity DB 400 such that the time of the corresponding file being stored is assigned to the condition information file 510. This enables whether a condition information file 510 stored in the storage 11 at a current time is changed by at least the predetermined threshold amount from the condition information file 510 stored at an immediately previous to the current time to be easily determined.

The physical activity information obtainer 110 is configured to successively obtain, from the sensors 32 of the HMD 3, the physical activity information file 520 associated with the condition information file 510 showing a corresponding one of the autonomous driving scenes, and store it in the condition/activity DB 400 each time the condition information file 510 is generated by the simulation executor 200.

As described above, the physical activity information file 520 includes the user's operation information items and user's physical activity information items measured by, for example, the sensors 32 of the HMD 3 and/or input from the input devices 7.

In particular, the physical activity information obtainer 110 is configured to store the physical activity information file 520 in the condition/activity DB 400 to be correlated with the condition information file 510 each time the physical activity information obtainer 110 obtains the condition information file 510 and the physical activity information file 520.

The physical activity information obtainer 110 can be configured to store the physical activity information file 520 in the condition/activity DB 400 while categorizing the physical activity information file 520 into plural information items.

For example, the physical activity information obtainer 110 can be configured to categorize the user's operation information items and user's biological information items included in the physical activity information file 520 into aggressive state items, i.e. data items, and calm state items, i.e. data items.

Specifically, the physical activity information obtainer 110 can be configured to sample time series data items measured from, for example, each of the head tracking sensor, acceleration sensor, line-of-sight sensor, and heart rate sensor for a predetermined period, and categorize the time series data items into frequency data items for the predetermined respective frequency components, the physical activity information obtainer 110 can be configured to

(1) Determine whether the frequency data items of each of the tracking of the user's head position, the movement of the predetermined user's portion, the user's line-of-sight, and the user's heart rate are higher than a predetermined threshold frequency

(2) Categorize some of the frequency data items of each of the tracking of the user's head position, the movement of the predetermined user's portion, the user's line-of-sight, and the user's heart rate, which are higher than the predetermined threshold frequency, into aggressive data items

(3) Categorize the remaining frequency data items of each of the tracking of the user's head position, the movement of the predetermined user's portion, the user's line-of-sight, and the user's heart rate, which are equal to or lower than the predetermined threshold frequency, into calm data items

As another example, the physical activity information obtainer 110 can be configured to

1. Sample time series data items measured from, for example, each of the blood pressure sensor and the sudorometer for a predetermined period

2. Determine whether the levels of the time series data items for each of the blood pressure sensor and the sudorometer are higher than a predetermined threshold level

3. Categorize some of the time series data items for each of the blood pressure sensor and the sudorometer, whose levels are higher than the predetermined threshold level, into aggressive data items

4. Categorize the remaining time series data items for each of the blood pressure sensor and the sudorometer, whose levels are equal to or lower than the predetermined threshold level, into calm data items

The physical activity information obtainer 110 can store each. physical activity information file 520 in the storage 11 such that the time of the corresponding file being stored is assigned to the physical activity information file 520. This enables whether a physical activity information. file 520 stored in the storage 11 at a current time is changed by at least a predetermined threshold amount from the physical activity information file 520 stored at an immediately previous to the current time to be easily determined.

When the condition obtainer 100 obtains the condition information file 510 and the physical activity information file 520, the parameter adjuster 120 is configured to analyze the condition information file 510 and the physical activity information file 520 to thereby determine values of the control parameters 410 of the autonomous driving simulation.

That is, the parameter adjuster 120 analyzes how the successively obtained physical activity information files 520 of a user have been changed in the virtual traffic environment, and evaluates how much the level of a secure feeling that the user has is ensured while the autonomous driving scenes are changed. In other words, even if the autonomous driving simulation of the own vehicle is carried out safely, a controlled value of, for example, the acceleration, the steering rate, or the following distance between a preceding vehicle and the own vehicle does not necessarily cause the driver to have a secure feeling.

For this reason, the parameter adjuster 120 sets adjusted values of at least one of the control parameters 410 suitable for respective different users while ensuring safe autonomous driving simulation of the own vehicle.

For example, when the condition obtainer 100 obtains the condition information file 510 and the physical activity information file 520, the parameter adjuster 120 is configured to

(1) Analyze the condition information file 510 and the physical activity information file 520

(2) Determine, based on the results of the analysis, whether a current autonomous driving scene represented by the current condition information file 510 has been changed from an immediately previous scene represented by the immediately previous condition information file 510 stored in the condition/activity DB 400

(3) Determine, based on the results of the analysis, whether a current user's physical activity level represented by the current physical activity information file 520 has been changed from an immediately previous user's physical activity level represented by the immediately previous physical activity information file 520 upon determining that the current autonomous driving scene has been changed from the immediately previous scene

(4) Change, i.e. adjust, a current value of at least one of the control parameters 410 to a different value of the corresponding at least one of the control parameters 410 upon determining that the current user's physical activity level has been changed from the immediately previous user's physical activity level

In particular, the parameter adjuster 120 can be configured to determine whether the current user's physical activity level has been changed from one of the aggressive state and the calm state to the other thereof.

This determination of whether the current user's physical activity level has been changed from the immediately previous user's physical activity level enables the parameter adjuster 120 to identify an autonomous driving scene during which the user's physical activity level has changed. Then, the parameter adjuster 120 adjusts values of the control parameters 410 for the identified autonomous driving scene. For example, the parameter adjuster 120 can calculate values of the control parameters 410 that prevents change of the user's physical activity level. That is, the parameter adjuster 120 adjusts values of the control parameters 410 to prevent change of the user's physical activity level while ensuring safe autonomous driving simulation of the own vehicle.

In particular, the parameter adjuster 120 can be configured to adjust a value of at least one of the control parameters 410 to thereby execute control of the autonomous driving simulation of the own vehicle in a more moderate manner.

For example, the parameter adjuster 120 is configured to

(1) Determine whether the current autonomous driving scene represented by the current condition information file 510 has been changed from the immediately previous scene represented by the immediately previous condition information file 510 stored in the condition/activity DB 400

(2) Change, i.e. adjust, a current value of at least one of the control parameters 410 to a different value of the corresponding at least one of the control parameters 410 in a more moderate manner upon determining that the current autonomous driving scene represented by the current condition information file 510 has been changed from the immediately previous scene represented by the immediately previous condition information file 510 stored in the condition/activity DB 400

(3) Reflect the adjusted value of the at least one of the control parameters 410 in control of the autonomous driving simulation of the own vehicle

As a first example, if the following distance between the own vehicle and a preceding vehicle ahead of the own vehicle has decreased in the current autonomous driving scene so that the user's physical activity level has been changed from the calm state to the aggressive state, the parameter adjuster 120 adjusts a current value of the following distance to be longer.

As a second example, if the acceleration of the own vehicle has increased in the current autonomous driving scene so that the user's physical activity level has been changed from the calm state to the aggressive state, the parameter adjuster 120 adjusts a current value of the acceleration to be smaller.

As a third example, if the deceleration of the own vehicle has increased in the current autonomous driving scene so that the user's physical activity level has been changed from the calm state to the aggressive state, the parameter adjuster 120 adjusts a current value of the deceleration to be smaller.

As a fourth example, if the steering rate of the own vehicle has increased in the current autonomous driving scene so that the user's physical activity level has been changed from the calm state to the aggressive state, the parameter adjuster 120 adjusts a current value of the steering rate to be lower.

This adjustment of the parameter adjuster 120 makes it possible to give the driver a secure feeling while ensuring safe autonomous driving simulation of the own vehicle.

Note that the parameter adjuster 120 determines whether the current user's physical activity level has been changed from the immediately previous user's physical activity level after determining that the current autonomous driving scene has been changed from the immediately previous scene. This determination order can be changed.

Specifically, the parameter adjuster 120 can determine whether the current autonomous driving scene has been changed from the immediately previous scene after determining that the current user's physical activity level has been changed from the immediately previous user's physical activity level.

In this modification, for example, the parameter adjuster 120 can be configured to determine whether the current user's physical activity level has been changed from one of the aggressive state and the calm state to the other thereof. Upon determining that the current user's physical activity level has been changed from one of the aggressive state and the calm state to the other thereof, the parameter adjuster 120 refers to the condition information file 510 corresponding to the current user's physical activity level to thereby identify a corresponding autonomous driving scene that results in the current user's physical activity level having been changed from one of the aggressive state and the calm state to the other thereof.

The parameter adjuster 120 can be configured to, after a sufficient number of condition information files 510 respectively correlated with a sufficient number of physical activity information files 520 have been stored in the storage 21, statistically analyze the sufficient number of condition information files 510 and the sufficient number of physical activity information files 520 being respectively correlated therewith using, for example, statistical testing. This enables both monitoring of the user's response in each of the autonomous driving scenes and analysis of a user's action in each of the autonomous driving scenes to be carried out.

After a predetermined period for which the user's physical activity level is in the calm state has elapsed, the parameter adjuster 120 can be configured to adjust at least one of the control parameters 410 to thereby cause the autonomous driving control of the own vehicle to be in a sharper manner, and reflect the adjusted value of the at least one of the control parameters 410 on control of the autonomous driving simulation.

The parameter setter adjuster can be configured to change values of the control parameters 410 within a predetermined range that enables safe autonomous driving of the own vehicle to be carried out.

This enables more efficient control of the autonomous driving simulation to be carried out while ensuring the autonomous driving simulation being safe and maintaining a user's physical activity level in the calm state.

Note that the condition information files 510 cyclically sent from each own vehicle can each include attribute information of a corresponding user; the attribute information can include, for example, the physical ability, the recognition ability, and/or driving ability of the corresponding driver. The parameter adjuster 120 in this modification can be configured to determine values of the respective control parameters 410 in accordance with the attribute information of the user. This modification therefore enables the values of the respective control parameters 410, which are optimally suitable for the physical ability, the recognition ability, and/or driving ability of each driver, to be determined.

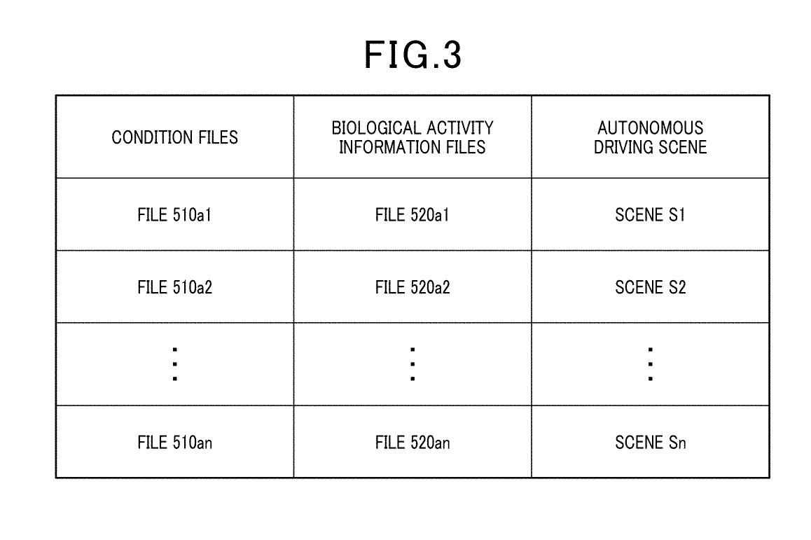

For example, FIG. 3 schematically illustrates that the condition files 510 (see 510a1 to 510an) respectively correlated with the physical activity information files 520 (see 520a1 to 520an) are stored in the storage 21 in, for example, a table format. In addition, the autonomous driving scenes represented by the respective condition files 510a1 to 510an are also illustrated as scenes S1 to Sn.

The condition/activity DB 40 is configured to store the condition information files 510 respectively corresponding to the driving-related conditions. As described above, each condition information file 500 stored in the condition DB 40 can be categorized into the vehicle control condition information, the time condition information, the weather condition information, the road condition information, the traffic condition information, and the hazardous condition information.

Note that the condition information files 510 can each include attribute information of a corresponding driver; the attribute information can include, for example, the age, the sex, the physical ability, the recognition ability, and/or driving ability of the corresponding user.

The control parameters 410 are setting data required to dynamically and safely control the own vehicle in each of the autonomous driving modes. Each control parameter 410 includes plural settings for executing autonomous driving control in the simulator 2. Based on commands sent from the adjustment apparatus 1, the simulation executor 200 can be configured to determine settings of the respective control parameters 410.

For example, as described above, the control parameters 410 include at least one of

(1) A setting of the following distance between the own vehicle and a preceding vehicle

(2) A setting of acceleration or deceleration of the own vehicle

(3) A setting of the steering rate of the own vehicle, which can be obtained based on the measurement signal sent from the steering sensor of the sensors 22

For example, the setting of the following distance can be adjustable within the range from a first distance that enables the own vehicle travelling at a specific speed to be completely and safely stopped to a second distance having a safety margin compared to the first distance.

As an example, the setting of acceleration or deceleration of the own vehicle can be set to a maximum value of acceleration or deceleration when the own vehicle is accelerated or decelerated in a safety state in the autonomous driving.

As another example, the setting of acceleration or deceleration of the own vehicle can be determined within the range from a fraction of the 1 g-force to half of the maximum value of acceleration or the maximum value of deceleration.

As an example, the setting of the steering rate can be set to a maximum value of the rate of steering change, i.e. a maximum value of an angular velocity, of the own vehicle when the own vehicle is safely tracking a curve.

As another example, the setting of the steering rate can be determined within the range from several degrees per second to tens of degrees per second. The setting of the steering rate can be determined as a functional equation of the curvature of a curve that the own vehicle is tracking.

The condition image data items 500 successively generated by the simulation executor 200 respectively represent various conditions appearing during execution of the autonomous driving simulation in the selected autonomous driving scenario. Each of the condition image data items 500 can be comprised of a pair of right and left images for the respective right and left eyes of a user, which can be displayed on the display 33 of the HMD 3.

Each of the condition information files 510 shows a corresponding one of the autonomous driving scenes in the selected autonomous driving scenario of the autonomous driving simulation carried out by the simulation executor 200. For this reason, the condition information files 510 can be generated by the simulation executor 200.

As described above, each condition information file 510 represents the conditions, i.e. situations, of the corresponding autonomous driving simulation. That is, each condition information file 510 can be comprised of information items (data items) including the vehicle control condition information, the time condition information, the weather condition information, the road condition information, the traffic condition information, the hazardous condition information, positional vectors of various stationary objects, moving vectors of traffic objects, setting data for the virtual traffic environment, and so on.

The time condition information represents which time period the own vehicle is travelling in, the time periods including, for example, morning, daytime, evening, and night time.

The weather condition information represents the weather condition, such as a bright condition, a rain condition, a cloud condition, a snow condition, a fog condition, or a sandstorm condition around the own vehicle.

The traffic condition information includes

1. The type of a road on which the own vehicle is travelling including whether the travelling road is an urban road or an express way, how many lanes the travelling road has, and whether there are oncoming lanes in the travelling road

2. Speed limit of the travelling road

3. Various traffic regulations

The positional vectors of various stationary objects include the position of each of pedestrians, other vehicles, buildings, obstacles, at least one sinkhole, at least one accident, fallen cargoes, and so on in the virtual reality space. The moving vectors of traffic objects include moving vectors, i.e. speeds, of various traffic objects including pedestrians and other vehicles in the virtual reality space. The setting data for the virtual traffic environment include data for establishing the virtual reality space and required for the simulation executor 200 to generate the condition image data items 500.

Note that the condition information files 510 can include the condition image data items 500, and the condition image data items 500 can be used to categorize the various conditions.

The physical activity information file 520 include physical activity information about a user who is feeling the autonomous driving simulation. The physical activity information file 520 can include information obtained by processing or categorizing information measured by, for example, the sensors 32 of the HMD 3.

The controller 10 of the adjustment apparatus 1 executes at least one of the control programs stored in the storage 11 to thereby serve as at least the condition obtainer 100, physical activity information obtainer 110, and parameter adjuster 120.

The controller 20 of the simulation executor 2 executes at least one of the control programs stored in the storage 21 to thereby serve as at least the simulation executor 200 and the information sender 210.

At least one hardware resource can constitute each of the modules 100, 110, 120, 200, and 210. At least one integrated circuit (IC), at least one digital signal processor, at least one programmed logic circuit or other similar hardware device can constitute at least part of the operations carried out by the controllers 10 and 20 described hereinbelow.

Next, the following describes an autonomous driving adjustment routine comprised of

(1) An autonomous driving simulation control routine carried out by the controller 20 of the simulator 2 every predetermined period

(2) A parameter setting routine carried out by the controller 10 of the adjustment apparatus 1 in cooperation with the controller 20

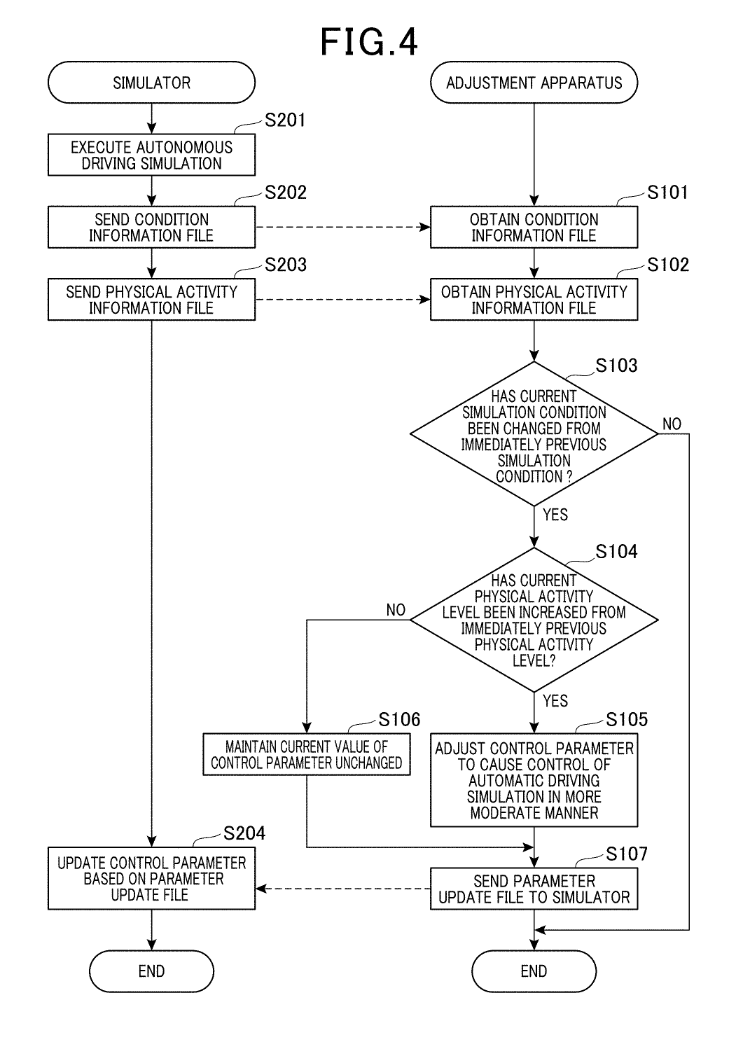

FIG. 4 schematically illustrates the autonomous driving adjustment routine. The following describes the autonomous driving adjustment routine cooperatively carried out by the controller 10 of the adjustment apparatus 1 and the controller 20 of the simulator 2.

When detecting that the HMD 3 is mounted on the head of the user U based on the measurement signal sent from the mount detection sensor 32, the controller 20 of the simulator 2 serves as the simulation executor 200 to execute an autonomous driving simulation in accordance with the control parameters 410 stored in the storage 21 in step S201.

For example, at least one of the autonomous driving scenarios can be prepared to include conditions associated with selected parameters in the control parameters 410 the selected parameters in the control parameters 410 are to be adjusted in particular.

Note that the simulation executor 200 is capable of executing the autonomous driving simulation as one scene of a game that gives a user autonomous driving of a vehicle and/or executing the autonomous driving simulation according to the scenes of a game.

Specifically, in step S201, the simulation executor 200 successively generates condition image data items 500 or successively reads out them from the storage 21 in accordance with a selected one of previously prepared autonomous driving scenarios, and successively sends the condition image data items 500 in the selected autonomous driving scenario to the HMD 3. This enables the condition image data items 500 to be successively displayed on the display 33 of the HMD 3 mounted on the head of the user U.

While successively rendering the condition image data items 500, i.e. the autonomous driving scenes, on the display 33 of the HMD 3, the simulation executor 200 successively generates condition information files 510 each of which shows a corresponding one of the autonomous driving scenes, and successively stores them in the storage 21 in step S201.

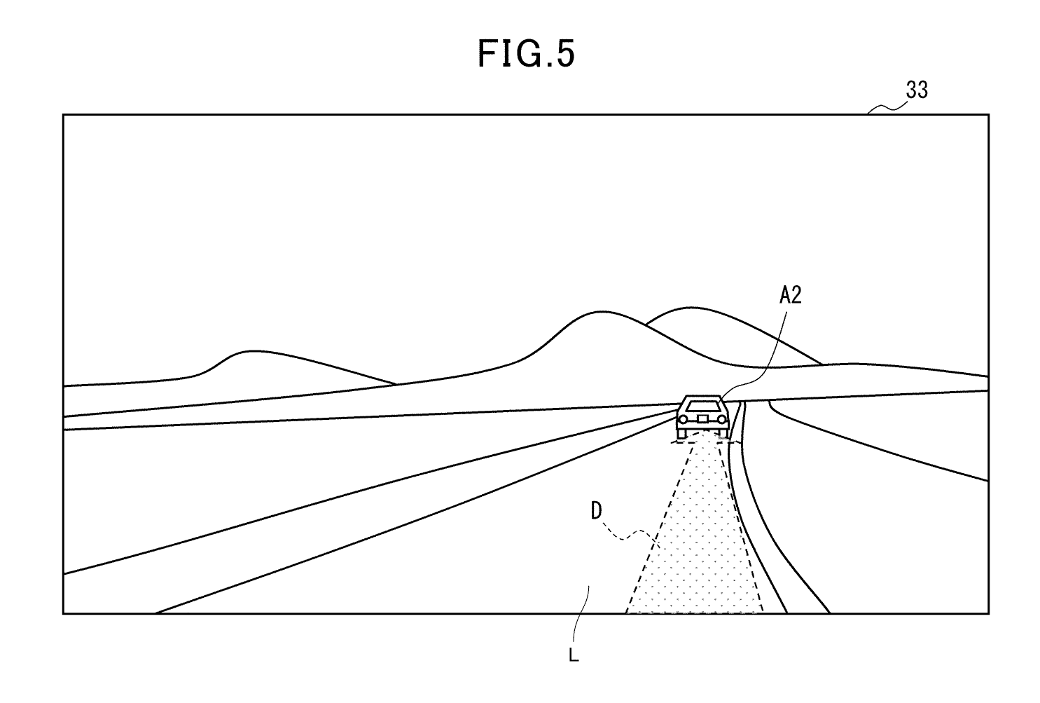

FIG. 5 schematically illustrates one autonomous driving scene displayed on the display 33 of the HMD 3; this scene includes the conditions where

1. The steering of the own vehicle is controlled to keep the own vehicle in a current travelling lane L

2. The speed of the own vehicle is controlled to leave a following distance D between the own vehicle and a previous vehicle A2 that is travelling at a predetermined speed

As described above, the controller 20 of the simulator 2 serves as the simulation executor 200 to execute the autonomous driving simulation in accordance with the control parameters 410 stored in the storage 21 in step S201.

Next, the information sender 210 successively sends, to the adjustment apparatus 1, the condition information files 510 representing the conditions of the autonomous driving simulation in step S202.

When the condition information file 510 is successively sent from the simulator 2, the condition obtainer 100 starts the parameter setting routine to successively obtain the condition information file 510 and stores it in the condition/activity DB 400 each time the condition information file 510 is sent thereto from the information sender 210 of the simulator 2 in step S101.

In step S101, the condition obtainer 100 can store the condition information file 510 in the condition/activity DB 400 while categorizing the condition information file 510 into the vehicle control condition information, the time condition information, the weather condition information, the road condition information, the traffic condition information, and the hazardous condition information.

In step S101, the condition obtainer 100 can store the condition information file 510 in the condition/activity DB 400 such that the time of the corresponding file being stored is assigned to the condition information file 510.

Following the operation in step S202, the information sender 201 of the simulator 2 receives the physical activity information files 520 measured by the sensors 32, each of which is associated with the condition information file 510 showing a corresponding one of the autonomous driving scenes, and temporarily stores them in the storage 21 in step S203. For example, the information sender 201 can store the physical activity information files 520 in the storage 21 in a queue, i.e. in a sequence configuration.

Then, the information sender 201 successively sends the physical activity information files 520 to the adjustment apparatus 1 in step S203. The information sender 201 can successively send the physical activity information files 520 to the adjustment apparatus 1 in response to a command sent from the physical activity information obtainer 110.

When the physical activity information file 520 is successively sent from the simulator 2, the physical activity information obtainer 110 successively obtains the the physical activity information file 520 and stores it in the condition/activity DB 400 each time the physical activity information file 520 is sent thereto from the information sender 210 of the simulator 2 in step S102.

In particular, the physical activity information obtainer 110 stores the physical activity information files 520 in the condition/activity DB 400 to be correlated with the corresponding condition information files 510 in step S102. The physical activity information obtainer 110 can store each of the physical activity information files 520 in the condition/activity DB 400 while categorizing the physical activity information file 520 into the aggressive state items and the calm state items in step S102. In step S102, the condition obtainer 100 can store the physical activity information file 520 in the condition/activity DB 400 such that the time of the corresponding file being stored is assigned to the physical activity information file 520.

For example, as illustrated in FIG. 3, the condition files 510 (see 510a1 to 510an) respectively correlated with the physical activity information files 520 (see 520a1 to 520an) are stored in the storage 21. In addition, the autonomous driving scenes represented by the respective condition tiles 510a1 to 510an are also illustrated as scenes S1 to Sn.

Next, the parameter adjuster 120 determines whether a current simulation condition represented by the currently obtained condition. information file 510 has been changed by at least a predetermined threshold amount from a previous simulation condition represented by a previous condition information file 510 obtained immediately previous to the currently obtained condition information file 510 in step S103.

As the example illustrated in FIG. 5, the parameter adjuster 120 determines whether a value of the following distance D as the traffic condition represented by the currently obtained condition information file 510 has been changed by at least the predetermined threshold amount from a value of the following distance D as the traffic condition represented by the previous condition information file 510 obtained immediately previous to the currently obtained condition information file 510 in step S103.

Upon it being determined that the current simulation condition has been changed by at least the predetermined threshold amount from the previous simulation condition (YES in step S103), the autonomous driving adjustment routine proceeds to step S104.

Otherwise, upon it being determined that the current simulation condition has not been changed by at least the predetermined threshold amount from the previous simulation condition (NO in step S103), the controller 10 terminates the current cycle of the parameter setting routine, and executes the next cycle of the parameter setting routine.

In the example illustrated in FIG. 5, the parameter adjuster 120 calculates a change of the following distance D based on a change of the moving vector of the preceding vehicle and a change of the speed of the own vehicle A2 based on comparison the traffic condition represented by the currently obtained simulation condition file 510 and the traffic condition represented by the previous simulation condition file 510 in step S103.

In the example illustrated in FIG. 5, the parameter adjuster 120 determines whether the calculated change of the following distance D has exceeded a predetermined threshold range in step S103.

Upon determining that the calculated change of the following distance D has exceeded the predetermined threshold range, the parameter adjuster 120 executes affirmative determination in step S103.

Otherwise, upon determining that the calculated change of the following distance D has not exceeded the predetermined threshold range, the parameter adjuster 120 performs negative determination in step S103.

Note that, in step S103, the parameter adjuster 120 can be configured to perform the determination for each of the remaining conditions, i.e. the vehicle control condition, the time condition, the weather condition, the road condition, and the hazardous condition information.

In step S104, the parameter adjuster 120 determines whether a current physical activity level represented by the currently obtained physical activity information file 520 has been increased by at least a predetermined threshold amount from a previous physical activity level represented by a previous physical activity information file 520 obtained immediately previous to the currently obtained physical activity information file 520 in step S104.

For example, the parameter adjuster 120 executes comparison analysis between the currently obtained physical activity information file 520 and the previous physical activity information file 520 to thereby determine whether the current physical activity level has been increased by at least the predetermined threshold amount from the previous physical activity level in step S104.

If the current physical activity level has been increased by at least the predetermined threshold amount from the previous physical activity level (YES in step S104), the parameter setting routine proceeds to step S105. Otherwise, the current physical activity level has not been increased by at least the predetermined threshold amount from the previous physical activity level (NO in step S104), the parameter setting routine proceeds to step S106.

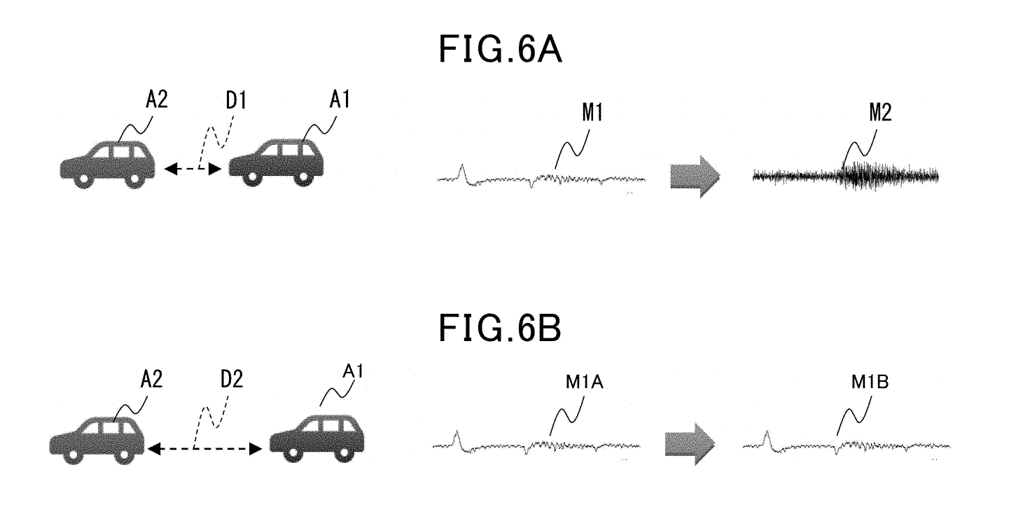

The following describes the operation in step S104 with reference to FIGS. 6A and 6B as an example.

FIG. 6A schematically illustrates that a current simulation condition in which the following distance between a virtual own vehicle A1 and a virtual preceding vehicle A2 has been changed to a smaller value D1.

FIG. 6A also illustrates

(1) The current frequency of movement of the user's head position represented by a measurement signal M2 included in the currently obtained physical activity information file 520

(2) The previous frequency of movement of the user's head position represented by a measurement signal M1 included in the previous physical activity information file 520 obtained immediately previous to the currently obtained physical activity information file 520

Because the current frequency of movement of the user's head position is clearly higher than the previous frequency of movement of the user's head position, the parameter adjuster 120 makes an affirmative determination in step S104, so that the parameter setting routine proceeds to step S105.

In contrast, FIG. 6B schematically illustrates that a current simulation condition in which the following distance between the own vehicle A1 and the preceding vehicle A2 has been changed to a larger value D2.

FIG. 6B also illustrates

(1) The current frequency of movement of the user's head position represented by a measurement signal M1B included in the currently obtained physical activity information file 520

(2) The previous frequency of movement of the user's head position represented by a measurement signal M1A included in the previous physical activity information file 520 obtained immediately previous to the currently obtained physical activity information file 520

Because the current frequency of movement of the user's head position is substantially identical to the previous frequency of movement of the user's head position, the parameter adjuster 120 makes a negative determination in step S104, so that the parameter setting routine proceeds to step S106.

In step S105, the parameter adjuster 120 executes a moderate adjustment task to adjust at least one of the control parameters 410 to thereby cause the autonomous driving control of the autonomous driving simulation to be in a more moderate manner.

For example, in step S105, the parameter adjuster 120 calculates a value of at least one of the control parameters 410, and changes the current value of at least one of the control parameters 410 in a more moderate manner. In the example illustrated in FIG. 6A, the parameter setter 410 changes a value of the following distance D to be longer.

Then, in step S105, the parameter adjuster 120 stores, in the storage 11, at least one of the control parameters 410 having the changed value to be correlated with the corresponding simulation condition as a data item of a control parameter update file.

Thereafter, the parameter setting routine proceeds to step S107.

In step S106, the parameter adjuster 120 executes a normal task to maintain the current value of each of the control parameters 410 unchanged. In the example illustrated in FIG. 6B, the parameter setter 410 keeps the value of the following distance D unchanged.

Note that, in step S106, the parameter adjuster 120 can be configured riot to perform anything, or configured to change the current value of at least one of the control parameters 410 in a sharper manner.

Following the operation in step S105 or S106, the parameter adjuster 120 sends the control parameter historical file F to the simulator 2 in step S107. Note that, in step S107, the parameter adjuster 120 can send, to the simulator 2, a command indicative of information about the control parameter historical file F.

Thereafter, the controller 10 terminates the current cycle of the parameter setting routine, and executes the next cycle of the parameter setting routine from step S101.

Following the operation in step S203, when the control data update file sent from the adjustment apparatus 1, the simulation executor 200 stores, in the storage 21, the received control parameter update file including the adjusted value of the at least one of the control parameters 410 in step S204. Then, in step S204, the simulation executor 200 updates the current value of the at least one of the control parameters 410, which is correlated with the current simulation condition, stored in the storage 21 to the adjusted value in accordance with the received control parameter update file. This enables the updated value of the at least one of the control parameters 410, which is correlated with the current simulation condition, i.e. the current autonomous driving scene, to be reflected on control of the autonomous driving simulation. Thereafter, the controller 10 terminates the autonomous driving simulation control routine.

Note that the parameter adjuster 120 can be configured to use, for example, a file transfer protocol (FTP) to thereby directly change the control parameters 410 stored in the storage 21 of the control apparatus 2a.

The parameter adjuster 120 can be configured not to perform the operations in steps S103 to S107 in real-time, i.e. during execution of the autonomous driving simulation, but to perform the operations in steps S103 to S107 after execution of the autonomous driving simulation is completed or when the number of data files in the condition/activity DB 400 has reached a threshold number.

That is, the parameter adjuster 120 can statistically analyze the condition files 510 (see 510a1 to 510an) and the physical activity information files 520 (see 520a1 to 520an) stored in the condition/activity DB 400 to thereby perform the operations in steps S103 to S107 after, for example, execution of the autonomous driving simulation. This enables the control parameter update file having a plurality of adjusted values of at least one of the control parameters 410 to be generated in the condition/activity DB 400.

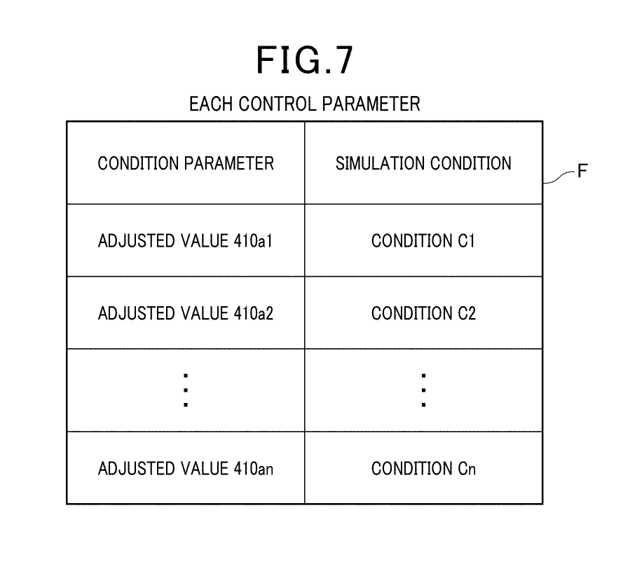

FIG. 7 schematically illustrates the control parameter update file (see reference character F) for one of the control parameters 410.

Specifically, each of simulation conditions C1 to Cn represents that the corresponding one of the simulation conditions C1 to Cn has been changed from the previous simulation condition immediately previous to the corresponding one of the simulation conditions C1 to Cn. In addition, each of adjusted values 410a1 to 410an represents an adjusted value determined by the parameter adjuster 120 when it is determined that the corresponding one of the simulation conditions C1 to Cn has been changed. The number of data items, i.e. the adjusted values 410a1 to 410an, for one of the control parameters 410 has reached to the number n.

Then, the parameter adjuster 120 can be configured to send the control parameter update file F to the simulator 2.

The adjusted values of each of the control parameter file F can be reflected on actual control of autonomous driving of vehicles, which are carried out by electronic control units (ECUs) of their vehicles.

As described in detail above, the autonomous driving adjustment system X according to the first embodiment achieves the following benefits.

Even if a conventional autonomous driving technology objectively ensures safety autonomous driving to drivers, all of various types of drivers do not necessarily have a sense of safety due to their individual differences. For this reason, many drivers seem to have an impersonal feeling about conventional autonomous driving, resulting in many drivers not easily feeling secure. Actually, autonomous driving control of a vehicle for safety can be adapted to the driver's driving tastes or senses. Adjustment of autonomous driving control of a vehicle based on driver's driving tastes enables whether a driver has a secure feeling or the level of a secure feeling that the driver has to be changed.

Flow much autonomous driving control of a vehicle is adjusted based on driver's tastes or senses and/or the level of drivers haying a secure feeling depend on the driver's individual differences. For this reason, it is desired to provide a method of adjusting autonomous driving control of a vehicle based on driver's tastes or senses, which is capable of offering a secure feeling to an average driver with a high probability.

Unfortunately, although the technology disclosed in the published patent document collects driving operations manually simulated by users, the technology may fail to disclose how the collected driving operations are reflected on adjustment of autonomous driving control suitable for driver's preferences.

From this viewpoint, the autonomous driving adjustment system X according to the first embodiment includes the simulator 2 for executing an autonomous driving simulation, and the adjustment apparatus 1 for adjusting the simulator 2.

The simulator 2 includes a simulation executor 200 and an information sender 210.

The simulation executor 200 is configured to execute an autonomous driving simulation in accordance with values of the control parameters 410 adjustable by the adjustment apparatus 1. The information sender 210 is configured to send, to the adjustment apparatus 1, the condition information file 510 showing a corresponding one of the autonomous driving scenes each time the simulation executor 200 generates the condition information file 510.

The adjustment apparatus 1 includes the condition obtainer 100 and the parameter adjuster 120.

The condition obtainer 100 is configured to obtain

(1) The condition information file 510 sent from the information sender 210

(2) The physical activity information file 520, which includes information indicative of physical activities of a user who is experiencing the autonomous driving simulation executed by the simulation executor 200, associated with the condition information file 510 each time the condition information file 510 is sent to the adjustment apparatus 1

The parameter adjuster 120 analyses the condition information file 510 and the physical activity information file 520, to thereby adjust a value of at least one of the control parameters 410 used by the autonomous driving simulation.

Analyzing a simulation condition of the autonomous driving based on the condition information file 510 and the user's physical activities associated with the simulation condition enables the user's preferences to the autonomous driving to be modeled, making it possible to carry out autonomous driving suitable for the user based on the modeled user's preferences.

For determining the relationships between driver's secure feelings and adjustment of the control parameters 410 for the automatic driving control based on driver's driving tastes, it may be necessary to collect a large amount of data about the driver's secure feelings with respect to adjustment of the control parameters 410, and analyze the collected data. In addition, because surveys are carried out to collection the data, it may be difficult to accurately collect the driver's secure feelings.

In contrast, the autonomous driving adjustment system X according to the first embodiment is configured to collect the relationship between the detailed driving-related conditions, i.e. autonomous driving scenes, and the user's physical activities correlated with each of the autonomous driving scenes. This configuration enables makes it possible to statistically model the user's preferences to be suitable for the user's driving tastes. This therefore makes it possible to adjust the control parameters 410 for the autonomous driving simulation or actual autonomous driving control based on the user's driving tastes, thus carrying out actual autonomous driving control or autonomous driving simulations while sufficiently meeting the user's preferences.

The adjustment apparatus 1 according to the first embodiment of the present disclosure is configured to adjust, as the control parameters 410 for the autonomous driving control, the following distance between the own vehicle and a preceding vehicle, the acceleration or deceleration of the own vehicle, and/or the steering rate of the own vehicle.

This configuration enables the following distance between the own. vehicle and the preceding vehicle, the acceleration or deceleration of the own vehicle, and/or the steering rate of the own vehicle to be controlled to be suitable for the driver's preferences, making it possible to carry out the autonomous driving simulation or actual autonomous driving of the own vehicle without the driver having an anxious feeling while ensuring the safety of the own vehicle.

The physical activity information file 520 obtained by the parameter adjuster 120 of the adjustment apparatus 1 includes at least one of

(1) Information indicative of movement of a user's portion

(2) Information indicative of change of a user's line-of-sight

(3) Information indicative of a user's heart rate

(4) Information indicative of a user's blood pressure

(5) Information indicative of a user's amount of perspiration

This configuration enables the parameter adjuster 120 to easily obtain the physical activity information file 520 from the sensors 32, and to categorize and/or analyze these information items. This makes it possible to accurately adjust the control parameters 410 to be suitable for the user's condition.

During the autonomous driving simulation or actual autonomous driving of the own vehicle, maximum extent control of the following distance, acceleration, or deceleration of the own vehicle may cause a user to have an anxious feeling or an uncomfortable feeling. This may result in how to execute the autonomous driving control suitable for the user's driving tastes being at the stage of trial and error.

From this viewpoint, the parameter adjuster 120 of the adjustment apparatus 1 is configured to adjust a value of at least one of the control parameters 410 to thereby execute control of the autonomous driving of the own vehicle in a more moderate manner.

This configuration enables maximum extent control for autonomous driving to be carried out while providing the driver from having a feeling of discomfort as much as possible, making it possible to perform autonomous driving of the own vehicle to be further suitable for the driver's preferences.

In addition, it may be difficult to perform tests for checking an adjustable range of each control parameter 410 for the automatic driving control; this adjustable range of each control parameter 410 shows whether a driver has an anxious feeling while the actual automatic driving is being carried out. In other words, it may be difficult to know an accurate range of adjustment of each control parameter 410 for the automatic driving control even while the safety of the automatic driving is ensured; this accurate range of adjustment of each control parameter 410 shows that, if an adjusted value of at least one of the control parameters 410 is set outside the accurate range, a corresponding driver seems to have an anxious feeling for the automatic driving control.

In contrast, the simulator 2 of the adjustment apparatus 1 is configured to

(1) Render, on the HMD 3, the condition image data items 500 respectively represent various conditions appearing during execution of the autonomous driving simulation

(2) Obtain, from the sensors 32 mounted to the HMD 33, the physical activity information file 520.

This configuration enables monitoring of user's responses and/or checking of user's actions to be carried out in a virtual reality world that has realism and is close to the real world. That is, it is possible to analyse the physical activity information file 520 while causing a user to experience various autonomous driving conditions, i.e. various autonomous driving scenes including some conditions, i.e. scenes, which may cause a user to have an anxious feeling. This therefore makes it possible to accurately evaluate how the level of a user's secure feeling is ensured for the user when the autonomous driving condition is changed.

In addition, obtaining the physical activity information file 520 from a user who is experiencing the autonomous driving simulation enables the physical activity data items of the user, which are highly correlated with the conditions of the autonomous driving simulation to be reliably obtained.

### Second Embodiment

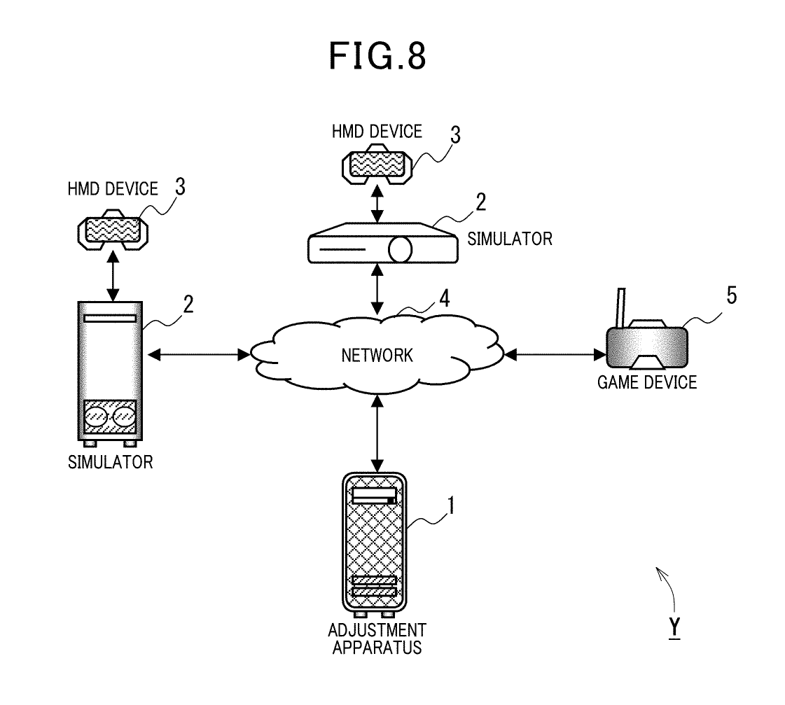

The following describes an autonomous driving adjustment system Y according to the second embodiment of the present disclosure with reference to FIG. 8. The configuration and functions of the autonomous driving adjustment system Y according to the second embodiment are mainly different from those of the autonomous driving adjustment system X according to the first embodiment. The following therefore mainly describes the different points.

The autonomous driving adjustment system Y includes the adjustment apparatus 1, the simulators 2, and the HMDs 3 respectively communicable with the simulators 2. The adjustment apparatus 1 and the simulators 2 are communicable with each other via a network 4. In addition, the autonomous driving adjustment system Y includes a game device 5 having all functions of the simulator 2 and the HMD 3; the game device 5 is communicable with the adjustment apparatus 1 and the simulators 2 via the network 4.

A cell-phone network, a wide area network, such as the internet®, or LAN, such as a Wi-Fi® network or wireless LAN, can be used as the network 4.

The functional configuration of each of the adjustment apparatus 1, the simulators 2, and the HMDs 3 can be identical to the functional configuration of the corresponding one of the adjustment apparatus 1, the simulators 2, and the HMDs 3. The adjustment apparatus 1 can be provided in plurality in the autonomous driving adjustment system Y.

Each of the simulators 2 can be configured to execute autonomous driving simulation as a game that causes a user to experience autonomous driving. The information obtainer 110 of the adjustment apparatus 1 is capable of obtaining the condition information file 510 together with user's operation information items; these user's operation information items include user's manual operations, such as an operation of the steering wheel, an operation of an accelerator pedal, and/or an operation of a brake pedal.

This configuration of the autonomous driving adjustment system Y makes it possible for users to experience autonomous driving simulation in the common virtual traffic environment via the network 4 while considering the simulation condition changes of each user, thus storing user's operation information items and user's physical activity information items and analyzing the stored information items.

That is, this configuration of the autonomous driving adjustment system Y enables user's responses and/or user's behaviours during execution of a common autonomous driving simulation in a virtual reality world that has realism and is close to the real world to be simultaneously monitored and analysed.

For example, it is possible to collect physical activity information items from users when the users are experiencing a common autonomous driving simulation, which can switch between an autonomous driving mode and a user's manual driving mode. This makes it possible to reflect, on actual autonomous driving of vehicles including autonomous vehicles and non-autonomous vehicles, values of each of the control parameters 410 that are suitable for the respective users.

The adjustment apparatus 1 and the simulator 2 are designed to be separate members, but the adjustment apparatus 1 and the simulator 2 can be designed as one integrated apparatus.

Each of the first and second embodiments is configured to render autonomous driving scenes in a virtual reality space on the HMD 33, but can be configured to render the autonomous driving scenes on a display device, such as a projector or a liquid crystal display. The HMD 3 can be provided with a steering wheel, user operable pedals, and movable seat. Each of the apparatuses 1, 2, 3, and 4 described in the first and/or second embodiments can include other functional blocks that are not disclosed in the specification.

While the illustrative embodiments of the present disclosure have been described herein, the present disclosure is not limited to the embodiments and their modifications described herein, but includes any and all embodiments having modifications, omissions, combinations (e.g., of aspects across various embodiments), adaptations and/or alterations as would be appreciated by those in the art based on the present disclosure within the scope of the present disclosure.

For example, each of the technical features described in the embodiments and their modifications can be replaced with a known structure having the same function as the corresponding technical feature. Each of the technical features described in the embodiments and their modifications can also be combined with at least one of the other technical features. At least one of the technical features described in the embodiments and their modifications can further be eliminated unless the at least one of the technical features is described as an essential element in the present specification. At least one of the elements disclosed in one of the first and second embodiments can be replaced with at least one of the elements disclosed in the other of the first and second embodiments.

What is claimed is:

1. An autonomous driving adjustment apparatus for adjusting at least one control parameter used for execution of an autonomous driving simulation, the autonomous driving adjustment apparatus comprising:
a condition obtainer configured to obtain condition information indicative of a simulation condition of the autonomous driving simulation;
a physical activity obtainer configured to obtain physical activity information about a user who is experiencing the autonomous driving simulation, the physical activity information being correlated with the obtained condition information; and
a parameter adjuster configured to analyse the condition information and the physical activity information to thereby adjust the at least one control parameter.

2. The autonomous driving adjustment apparatus according to claim 1, wherein:
the at least one control parameter includes at least one of:
a following distance between a virtual own vehicle and a virtual preceding vehicle;
acceleration of the virtual own vehicle;
deceleration of the virtual own vehicle; and
a steering rate of the virtual own vehicle.

3. The autonomous driving adjustment apparatus according to claim 1, wherein:
the physical activity information includes at least one of:
first information indicative of movement of a user's portion;
second information indicative of change of a user's line-of-sight;
third information indicative of a user's heart rate;
fourth information indicative of a user's blood pressure; and
fifth information indicative of a user's amount of perspiration.

4. The autonomous driving adjustment apparatus according to claim 1, wherein:
the parameter adjuster is configured to adjust the at least one control parameter to thereby cause control of the autonomous driving simulation to be more moderate.

5. The autonomous driving adjustment apparatus according to claim 1, wherein:
the condition obtainer is configured to successively obtain, as the condition information, a first condition information item and a second condition information item, each of the first condition information item and second condition information item representing a corresponding one of a first simulation condition and a second simulation condition of the autonomous driving simulation;
the physical activity obtainer is configured to successively obtain, as the physical activity information, a first physical activity information item and a second physical activity information item about the user, each of the first and second physical activity information items having a level of a corresponding physical activity and being correlated with a corresponding one of the first and second condition information items; and
the parameter adjuster is configured to:
determine whether the second condition information item has been changed from the first condition information item;
determine whether the level of the physical activity of the second physical activity information item has been increased from the level of the physical activity of the first physical activity information item upon determining that the second condition information item has been changed from the first condition information item; and
adjust a value of the at least one control parameter for the second condition information item upon determining that the level of the physical activity of the second physical activity information item has been increased from the level of the physical activity of the first physical activity information item.

6. The autonomous driving adjustment apparatus according to claim 5, wherein:
the parameter adjuster is configured to store the adjusted value of the at least one control parameter to be correlated with the second condition information item.

7. An autonomous driving adjustment system comprising:
a simulator; and
an autonomous driving adjustment apparatus,
the simulator comprising:
a simulation executor configured to execute an autonomous driving simulation; and
an information sender configured to send, to the autonomous driving adjustment apparatus, condition information indicative of a simulation condition of the autonomous driving simulation executed by the simulation executor;
the autonomous driving adjustment apparatus comprising:
a condition obtainer configured to obtain the condition information indicative of the simulation condition of the autonomous driving simulation;
a physical activity obtainer configured to obtain physical activity information about a user who is experiencing the autonomous driving simulation, the physical activity information being correlated with the obtained condition information; and
a parameter adjuster configured to analyse the condition information and the physical activity information to thereby adjust the at least one control parameter.

8. The autonomous driving adjustment system according to claim 7, wherein:
the simulation executor is configured to render, on a head mounted display device mounted on a head of the user, the head mounted display device including at least one sensor that measures the physical activity information about the user; and
the physical activity obtainer is configured to obtain the physical activity information about the user from the at least one sensor.

9. The autonomous driving adjustment system according to claim 7, wherein;
the simulation executor is configured to execute a game that causes the user to experience the autonomous driving simulation; and
the condition obtainer is configured to obtain the condition information together with user's operation information during the game.

10. An autonomous driving adjustment method for adjusting at least one control parameter used for execution of an autonomous driving simulation, the autonomous driving adjustment method comprising:
obtaining condition information indicative of a simulation condition of the autonomous driving simulation;
obtaining physical activity information about a user who is experiencing the autonomous driving simulation, the physical activity information being correlated with the obtained condition information; and
analyzing the condition information and the physical activity information to thereby adjust the at least one control parameter.
